(19) United States
(12) Patent Application Publication
(10) Pub. No.: US 2009/0229583 A1
(43) Pub. Date: Sep. 17, 2009

(54) MOTOR POPPET VALVE AND AN EGR DEVICE FOR AN INTERNAL COMBUSTION ENGINE USING THE SAME

(75) Inventors: Seijiro Kotooka, Kanagawa (JP); Susumu Kohketsu, Kanagawa (JP); Hitoshi Yokomura, Kanagawa (JP)

Correspondence Address: ROSSI, KIMMS & McDOWELL LLP., 20609 Gordon Park Square, Suite 150, Ashburn, VA, 20147, US

(73) Assignee: MITSUBISHI FUSO TRUCK AND BUS CORPORATION, Kawasaki-shi (JP)

(21) Appl. No.: 11/720,993

(22) PCT Filed: Dec. 2, 2005
(86) PCT No.: PCT/JP05/22203

§ 371 Date: Sep. 11, 2007

(30) Foreign Application Priority Data
Dec. 7, 2004 (JP) 2004-354400

(51) Int. Cl. F02M 25/07; F01L 9/04

(52) U.S. Cl. 123/568.18; 123/90.11; 123/188.2

(57) ABSTRACT

Motor control means of a motor poppet valve has initial motor torque setting means for setting the initial motor torque of an electric motor so that the initial motor torque equals a torque corresponding to a force biasing a valve element of a poppet-valve body toward a valve seat or a proximate value, and drives the electric motor so as to obtain the initial motor torque when driving the electric motor to detach the valve element from the valve seat.

### TECHNICAL FIELD

The present invention relates to a motor poppet valve and an EGR device for an internal combustion engine using the motor poppet valve.

### BACKGROUND ART

An internal combustion engine, whether it be a gasoline engine or a diesel engine, has a tendency to employ an EGR device (exhaust gas recirculation device) that recirculates a portion of exhaust gases to the intake system mainly for reducing NOx.

In general, an EGR passage is provided with an EGR valve, which allows and prohibits the communication of EGR gas and regulates the amount of communication.

Particularly, an important feature of the EGR valve is its high sealability exhibited when blocking the communication of EGR gas. In order to secure a stable sealability even in the situation where there is a great differential pressure between the upstream side and the downstream side of the EGR valve, a poppet valve that is constantly closed by the biasing force of a contracted spring is generally utilized. The poppet valve is opened by being pressed, resisting the biasing force of the spring. By so doing, a flow rate of EGR gas is regulated. One example of means for pressing the poppet valve is an air-driven type using a solenoid. In addition, another type that uses the driving force of an electric motor (step motor, for example) (motor poppet valve) has recently been developed for its high controllability.

As a flow rate change of a poppet valve is great when the valve is in its small opening position, it is required to regulate the flow rate of EGR gas with accuracy when the valve is in its small opening position.

There generates a great differential pressure in EGR gas between the upstream side (exhaust side) and the downstream side (intake side) of the EGR valve. This differential pressure fluctuates according to operation conditions of the internal combustion engine. If such a differential pressure is produced and also fluctuates, and if the EGR valve is a poppet valve, a force corresponding to the differential pressure acts on a valve element of the poppet valve and has an effect on the operation of the poppet valve.

A device has been developed, in which, for example, a drive rate of an electric motor is controlled to change according to a fluctuating differential pressure if a motor poppet valve is utilized as an EGR valve. The device is disclosed, for example, in Japanese Patent Application Publication No. 11-351075 (hereinafter, referred to as patent document).

When a poppet valve that is biased by a spring into its constantly closed position is utilized as mentioned above, it is required to resist the biasing force of the contracted spring in order to open the poppet valve.

However, for instance, in the case of a motor poppet valve that performs general PID control, a motor torque is gradually increased from zero when the electric motor is activated. Therefore, at least before the motor torque reaches the biasing force of the spring (spring set force), the poppet valve is not activated. Accordingly, there is the problem that response is delayed until the poppet valve is actually opened, and the technology disclosed in the above patent document is not an exception.

The smaller the desired opening of the poppet valve is (low valve lift), and the lower the drive rate of the motor is, that is, the slower the start-up of the motor torque is, the more noticeable the above-mentioned problem grows, as illustrated in FIG. 4 showing, with variations of desired opening, the motor torque of the motor poppet valve and the change of valve opening with time when general PID control is implemented.

Such a response delay in the opening of the poppet valve is undesirable because control accuracy is drastically deteriorated especially in slight opening of the poppet valve, for a reason that opening timing is not stabilized, and the like.

### DISCLOSURE OF THE INVENTION

The present invention has been made to solve the above-mentioned problem. It is an object of the present invention to provide a motor poppet valve that can be controlled into its open position with accuracy and without response delay, and an EGR device for an internal combustion engine using such a motor poppet valve.

In order to achieve the object, the motor poppet valve of the present invention has a poppet-valve body including a valve element interposed in a fluid passage and a stem portion extending through an outer shell of the fluid passage to protrude outside the fluid passage, in which the valve element is brought into contact with a valve seat formed in the outer shell to block a flow of fluid running through the fluid passage, and the valve element is detached from the valve seat to allow communication of the fluid; a spring cap that is fitted on a stem head portion of the poppet-valve body; a spring that is disposed in between the spring cap and the outer shell of the fluid passage in a contracted position and biases the valve element so that the valve element contacts the valve seat; a shaft that is disposed coaxially with the axis of the stem portion of the poppet-valve body and moves in the axial direction to press the stem head portion; an electric motor that has a rotor screwed onto the shaft and reciprocates the shaft by rotating the rotor forward and backward; and motor control means for controlling the operation of the electric motor. The motor poppet valve is characterized in that the motor control means has initial motor torque setting means for setting an initial motor torque of the electric motor so that the initial motor torque equals a torque corresponding to a force biasing the valve element toward the valve seat or a value proximate thereto, and drives the electric motor so as to obtain the initial motor torque that is set by the initial motor torque setting means when driving the electric motor in order to press the stem head portion by means of the shaft and to detach the valve element from the valve seat.

### BRIEF DESCRIPTION OF THE DRAWINGS

FIG. 1 is a sectional view showing a schematic configuration of an EGR device for an internal combustion engine using a motor poppet valve according to the present invention;

FIG. 2 is a time chart showing opening of an EGR valve formed of the motor poppet valve and change of a motor torque with time during a time period between start and stop of an engine and is also a view for explaining a method of estimating a spring set force;

FIG. 3 is a time chart showing motor torques and change of valve opening with time in comparison between the present invention in which initial motor torque is in consideration (b) and conventional art in which initial motor torque is not in consideration (a); and

FIG. 4 is a view showing, with variations of desired opening, motor torque of the motor poppet valve and change of the valve opening with time when general PID control is implemented.

### BEST MODE OF CARRYING OUT THE INVENTION

An embodiment of the present invention will be described below with reference to the attached drawings.

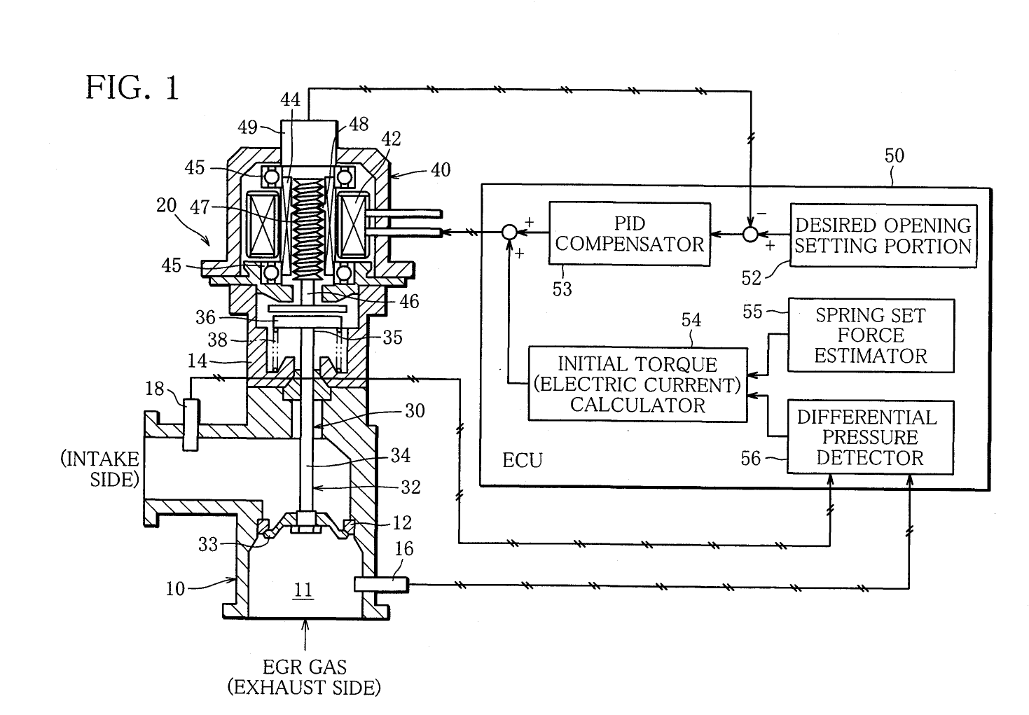

FIG. 1 shows a sectional view of a schematic configuration of an EGR device for an internal combustion engine using a motor poppet valve according to the present invention. Hereinafter, a configuration of the motor poppet valve according to the present invention and that of the EGR device for an internal combustion engine using the motor poppet valve will be described below with reference to FIG. 1.

As illustrated in FIG. 1, an EGR valve 20 formed of a motor poppet valve is interposed in an EGR duct 10 that is installed in an engine (internal combustion engine, not shown) and recirculates EGR gas (fluid) that is a portion of exhaust gases to an intake system.

The EGR valve 20 is roughly made up of a poppet valve 30 and a motor portion 40.

The poppet valve 30 is formed of a poppet-valve body 32 consisting chiefly of a valve element 33 and a stem 34, and a spring 38.

More specifically, the valve element 33 of the poppet-valve body 32 is disposed within the EGR duct 10. A valve seat 12 is formed in the inner circumference of the EGR duct 10. The poppet-valve body 32 is constructed so that the valve element 33 blocks off an EGR passage 11 in the EGR duct 10 by bringing the circumferential edge thereof into contact with the valve seat 12, and opens the EGR passage 11 by detaching the circumferential edge thereof from the valve seat 12. In other words, the poppet valve 30 is driven to a closed position when the valve element 33 of the poppet-valve body 32 contacts the valve seat 12, whereas the poppet valve 30 is driven to an open position when the valve element 33 moves away from the valve seat 12.

The stem 34 of the poppet-valve body 32 extends through the EGR duct 10 to protrude outside. A spring cap 36 is fitted on a stem head 35 at the end of the stem 34. The spring 38 is disposed in a contracted position in between the spring cap 36 and a valve case 14 formed integrally with the EGR conduct 10. Accordingly, the valve element 33 of the poppet-valve body 32 is usually in contact with the valve seat 12 due to a biasing force of the spring 38, so that the poppet valve 30 functions as a normally-closed valve.

The motor portion 40 consists chiefly of an electromagnetic coil 42, a rotor 44, and a shaft 46.

To be concrete, the rotor 44 is supported by a bearing 45, and is rotated (autorotated) when being excited by the electromagnetic coil 42. The rotor 44 also has a hollow form. The shaft 46 is interfitted in the hollow portion.

The shaft 46 is located coaxially with the axis of the stem 34 of the poppet-valve body 32. The stem head 35 of the poppet-valve body 32 can be pressed by the shaft 46 moving in the axial direction.

A screw 47 is formed in the outer circumference of the shaft 46. A screw projection 48 is formed in the inner circumference of the rotor 44 so as to be engaged with the screw 47. As a result, when the rotor 44 is excited by the electromagnetic coil 42 to be rotated (rotated forward and backward), the screw projection 48 moves along the screw 47, and the shaft 46 can reciprocate (appear and hide) in the axial direction of the stem 34.

Stated differently, the EGR valve 20 is constructed so that when the rotor 44 is rotated forward to move the shaft 46 to an appear side, the poppet-valve body 32 is pressed by the shaft 46, and the valve element 33 is detached from the valve seat 12 to move to the open position, and when the rotor 44 is rotated backward to move the shaft 46 to a hide side, the poppet-valve body 32 is returned by the biasing force of the spring 38, and the valve element 33 is brought into contact with the valve seat 12 to move to the closed position.

The EGR valve 20 is provided with a position sensor 49 for detecting a move amount of the shaft 46, and accordingly, actual opening of the EGR valve 20, by detecting a rotation angle of the rotor 44. A pressure sensor 16 and a pressure sensor 18 are interposed in the EGR duct 10 in the upstream side (exhaust system side) and in the downstream side (intake system side) of the valve element 33, respectively, for the purpose of detecting pressure of the EGR gas.

The EGR valve 20 is electrically connected to an ECU (electric control unit, motor control means) 50.

Concretely, the pressure sensors 16 and 18, the position sensor 49, and the like, and a battery, not shown, are connected to an input side of the ECU 50. Connected to an output side of the ECU 50 are the electromagnetic coil 42 and the like.

As illustrated by a block diagram in FIG. 1, the ECU 50 is provided with a desired opening setting section 52, a PID compensator 53, an initial torque (electric current) calculator (initial motor torque setting means) 54, a spring set force estimator 55, and a differential pressure detector (differential pressure detection means) 56.

The desired opening setting section 52 has a function of setting a desired EGR amount, namely desired opening of the EGR valve 20 based upon operation conditions of the engine and the like, and of outputting a desired opening signal corresponding to the desired opening. The PID compensator 53 is formed of a proportional controller, an integral controller, and a differential controller. The PID compensator 53 has a function of regulating a motor torque to be applied to the motor portion 40, that is, an electric current value to be supplied to the electromagnetic coil 42, while conducting the PID control based upon feedback deviation between the desired opening signal and an actual opening signal of the EGR valve 20, which is detected by the position sensor 49, and of outputting the electric current value to the electromagnetic coil 42.

The initial torque (electric current) calculator 54 has a function of calculating an initial motor torque to be applied to the motor portion 40, namely an initial electric current value to be supplied to the electromagnetic coil 42, and of outputting the initial electric current value to the electromagnetic coil 42 together with the electric current value regulated according to the desired opening signal.

To be specific, the initial torque (electric current) calculator 54 is inputted with spring set force information that is estimated by the spring set force estimator 55, or biasing force information of the contracted spring 38 of the poppet valve 30, and is also inputted with differential pressure information of the EGR gas between the upstream side (exhaust system side) and the downstream side (intake system side) of the valve element 33, which are detected on the basis of information from the pressure sensors 16 and 18 in the differential pressure detector 56. In the initial torque (electric current) calculator 54, the initial motor torque, or initial electric current value, is calculated on the basis of the spring set force information and the differential pressure information of the EGR gas.

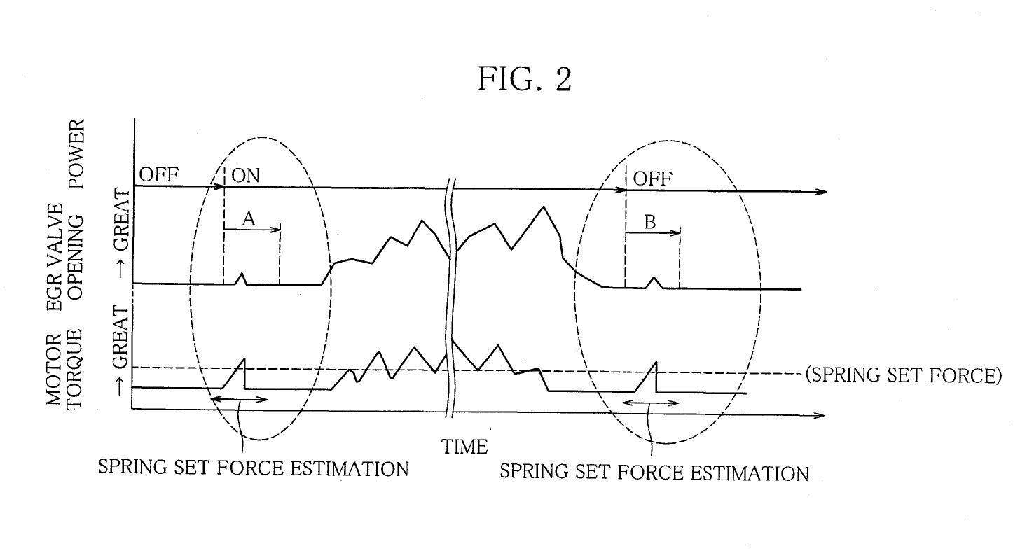

The spring set force estimator 55 may measure the biasing force of the contracted spring 38 beforehand. In this specification, however, in consideration of change with time and the like, for instance, as illustrated in a time chart in FIG. 2 showing the opening of the EGR valve 20 and change of the motor torque with time during a time period between start (power ON) and stop (power OFF) of the engine, and as shown by circular broken lines in FIG. 2, the electromagnetic coil 42 is supplied with electric current to continuously apply motor torques by force in a prescribed period A immediately after the start of the engine (immediately after the power is turned ON) in such a condition that exhaust pressure does not act on the valve element 33 and in a prescribed period B immediately after the stop of the engine (immediately after the power is turned OFF). A motor torque at a time point when the EGR valve 20 starts to open is estimated as a spring set force.

In practice, the motor torque at the time point when the EGR valve 20 starts to open is not always fixed due to temperature change, property change of the spring 38, control fluctuation, and the like. Therefore, the spring set force estimator 55 sets and outputs as the spring set force a value that is a little smaller than an estimated value (proximate value) of the motor torque so that the EGR valve 20 is not opened only by applying the estimated value of the motor torque.

The differential pressure detector 56 obtains an EGR gas pressure which acts on the valve element 33 by multiplying the detected differential pressure of the EGR gas by a projected area of the valve element 33, to thereby output the EGR gas pressure.

In the initial torque (electric current) calculator 54, a torque corresponding to a force obtained by adding the EGR gas pressure to the spring set force is calculated as the initial motor torque. The initial electric current value corresponding to the initial motor torque is outputted to the electromagnetic coil 42.

Hereinafter, operations of the motor poppet valve according to the present invention thus constructed and the EGR device for an internal combustion engine using the motor poppet valve will be described.

When it is required to recirculate the EGR gas to the intake system according to operation conditions of the engine, and the ECU 50 outputs an open-valve command for the EGR valve 20, the desired opening is determined by the desired opening setting section 52. At the same time, based upon the feedback deviation between the desired opening signal and the actual opening signal of the EGR valve 20, the electric current value to be supplied to the electromagnetic coil 42 is regulated by the PID compensator 53, and the electric current value is outputted to the electromagnetic coil 42.

To put it briefly, by using the PID compensator 53, the electric current value is outputted to the electromagnetic coil 42 while being gradually increased toward an electric current value corresponding to the desired opening through the PID control.

At the same time with the output of the open-valve command of the EGR valve 20, the initial torque (electric current) calculator 54 calculates as the initial motor torque the torque corresponding to the force obtained by adding the EGR gas pressure to the spring set force, and the initial electric current value corresponding to the initial motor torque is outputted to the electromagnetic coil 42.

When the initial electric current value corresponding to the initial motor torque is outputted to the electromagnetic coil 42, for example, if there is no initial electric current value, the electric current value from the PID compensator 53, or motor torque, is gradually increased by the PID control. The EGR valve 20 is not opened until the motor torque reaches a torque capable of opening the EGR valve 20, that is, the torque corresponding to the force obtained by adding the EGR gas pressure corresponding to the differential pressure between before and after the EGR valve 20 to the biasing force of the spring 38. As a result, there generates response delay during this period. However, the motor portion 40 is immediately activated in order to obtain the initial motor torque, so that the response delay is solved, and the EGR valve 20 serving as a motor poppet valve is instantaneously opened with good response.

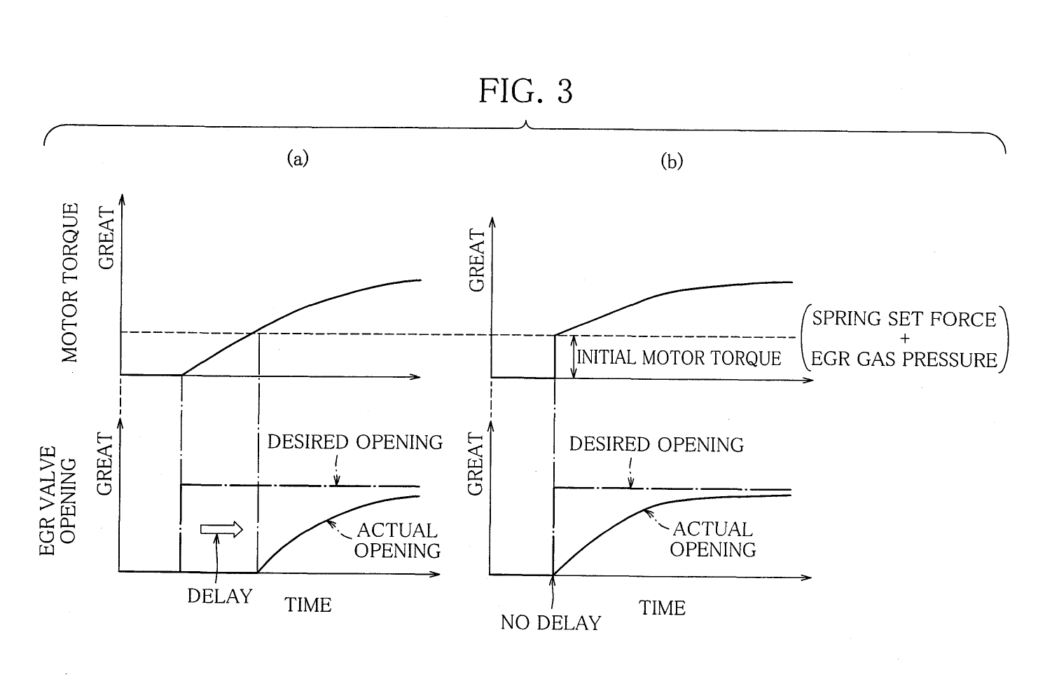

FIG. 3 shows the motor torque of the EGR valve 20 serving as a motor poppet valve and change of valve opening with time in the form of a time chart in comparison between conventional art in which the initial motor torque is not in consideration (a) and the present invention in which the initial motor torque is in consideration (b). As illustrated in FIG. 3, the response delay of the EGR valve 20 as in conventional art is solved by applying the initial motor torque. Therefore, the motor torque at once reaches the torque corresponding to the force obtained by adding the EGR gas pressure to the spring set force substantially at the same time with the output of the open-valve command for the EGR valve 20. Accordingly, the EGR valve 20 quickly starts moving to the open position. Thereafter, the EGR valve 20 is satisfactorily controlled into the open position by stages toward the desired opening by feedback control and the PID control.

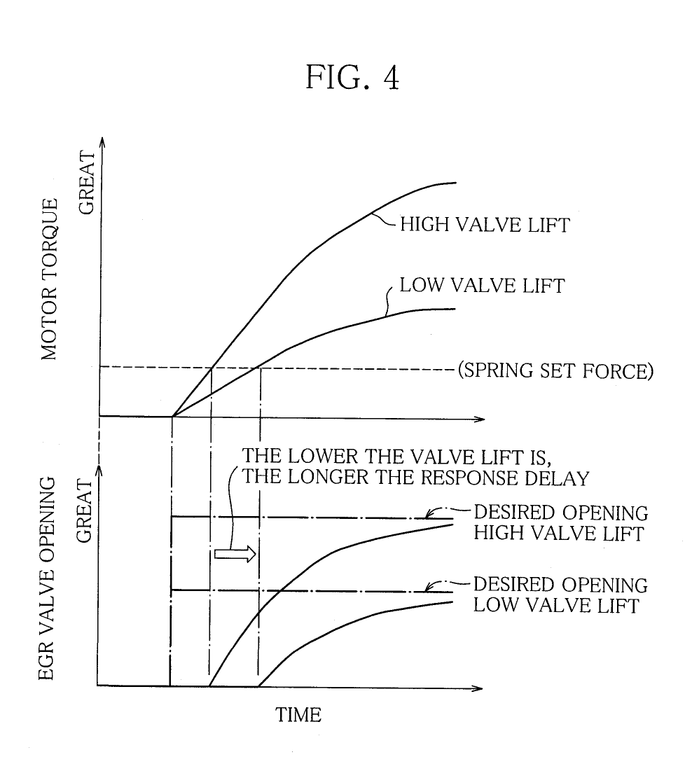

If the EGR valve 20 is a motor poppet valve, the smaller the desired opening of the EGR valve 20 is (low valve lift), that is, the slower the start up of the motor torque is, the greater the response delay tends to be (see FIG. 4). However, by doing as described above, it is possible to enhance the response of the EGR valve 20 regardless of the desired opening and to improve control accuracy especially in slight opening of the EGR valve 20.

The embodiment of the present invention has been described here, but an aspect is not limited to the above-mentioned embodiment.

For instance, in the embodiment, the spring set force estimator 55 estimates the spring set force in the prescribed period A immediately after the start of the engine (immediately after the power is turned ON) and in the prescribed period B immediately after the stop of the engine (immediately after the power is turned OFF). However, the spring set force may be estimated in either one of the prescribed periods A and B.

According to the embodiment, the initial torque (electric current) calculator 54 calculates as the initial motor torque the torque corresponding to the force obtained by adding the EGR gas pressure to the spring set force, and outputs the initial electric current value corresponding to the initial motor torque to the electromagnetic coil 42. However, since most of the force biasing the valve element 33 toward the valve seat 12 is the biasing force of the contracted spring 38, the initial motor torque, namely the initial electric current value, may be set based only upon the torque corresponding to the spring set force. In short, the pressure sensors 16 and 18 and the differential pressure detector 56 may be omitted. In this manner, too, it is possible to properly set the initial motor torque, and accordingly, the initial electric current value, and to gain full advantage. Needless to say, however, if the EGR gas pressure is applied as in the embodiment, the initial motor torque can be more properly determined regardless of operation conditions of the engine.

Although the embodiment has been described with reference to the example in which the motor poppet valve is employed as the EGR valve 20, the present invention is not limited to this example. It is a matter of course that the present invention is applicable to all kinds of motor poppet valves regardless of their uses.

1. A motor poppet valve comprising:
a poppet-valve body including a valve element interposed in a fluid passage and a stem portion extending through an outer shell of the fluid passage to protrude outside the fluid passage, in which the valve element is brought into contact with a valve seat formed in the outer shell to block a flow of fluid running through the fluid passage, and the valve element is detached from the valve seat to allow communication of the fluid;
a spring cap that is fitted on a stem head portion of the poppet-valve body;
a spring that is disposed in between the spring cap and the outer shell of the fluid passage in a contracted position and biases the valve element so that the valve element contacts the valve seat;
a shaft that is disposed coaxially with the axis of the stem portion of the poppet-valve body and moves in the axial direction to press the stem head portion;
an electric motor that has a rotor screwed onto the shaft and reciprocates the shaft by rotating the rotor forward and backward; and
motor control means for controlling the operation of the electric motor;
wherein the motor control means has initial motor torque setting means for setting an initial motor torque of the electric motor so that the initial motor torque equals a torque corresponding to a force biasing the valve element toward the valve seat or a value proximate thereto, and drives the electric motor so as to obtain the initial motor torque that is set by the initial motor torque setting means when driving the electric motor in order to press the stem head portion by means of the shaft and to detach the valve element from the valve seat.

2. The motor poppet valve according to claim 1, characterized in that:
the initial motor torque setting means sets the initial motor torque of the electric motor so that the initial motor torque equals a torque corresponding to a biasing force of the contracted spring or a value proximate thereto.

3. The motor poppet valve according to claim 2, characterized in that:
the motor control means further has differential pressure detection means for detecting differential pressure between upstream fluid pressure in an area upstream from the valve element in the fluid passage and downstream fluid pressure in an area downstream from the valve element, and
the initial motor torque setting means sets the initial motor torque of the electric motor so that the initial motor torque equals a torque corresponding to a force obtained by adding a force corresponding to differential pressure between the upstream fluid pressure and the downstream fluid pressure which are detected by the differential pressure detection means to the biasing force of the contracted spring or a value proximate thereto.

4. An EGR device for an internal combustion engine, comprising:
an EGR duct for recirculating a portion of exhaust gases from an exhaust system to an intake system as EGR gas; and
an EGR valve that is interposed in the EGR duct and regulates a flow rate of the EGR gas recirculated through the EGR duct;
wherein the EGR valve includes a motor poppet valve (20) comprising:
a poppet-valve body including a valve element interposed in a fluid passage and a stem portion extending through an outer shell of the fluid passage to protrude outside the fluid passage, in which the valve element is brought into contact with a valve seat formed in the outer shell to block a flow of fluid running through the fluid passage, and the valve element is detached from the valve seat to allow communication of the fluid;
a spring cap that is fitted on a stem head portion of the poppet-valve body;
a spring that is disposed in between the spring cap and the outer shell of the fluid passage in a contracted position and biases the valve element so that the valve element contacts the valve seat;
a shaft that is disposed coaxially with the axis of the stem portion of the poppet-valve body and moves in the axial direction to press the stem head portion;
an electric motor that has a rotor screwed onto the shaft and reciprocates the shaft by rotating the rotor forward and backward; and
motor control means for controlling the operation of the electric motor;
wherein the motor control means has initial motor torque setting means for setting an initial motor torque of the electric motor so that the initial motor torque equals a torque corresponding to a force biasing the valve element toward the valve seat or a value proximate thereto and drives the electric motor so as to obtain the initial motor torque that is set by the initial motor torque setting means when driving the electric motor in order to press the stem head portion by means of the shaft and to detach the valve element from the valve seat.

5. An EGR device for an internal combustion engine as claimed in claim 4, characterized in that:
the initial motor torque setting means sets the initial motor torque of the electric motor so that the initial motor torque equals a torque corresponding to a biasing force of the contracted spring or a value proximate thereto.

6. An EGR device for an internal combustion engine as claimed in claim 4, characterized in that:
the motor control means further includes differential pressure detection means for detecting differential pressure between upstream fluid pressure in an area upstream from the valve element in the fluid passage and downstream fluid pressure in an area downstream from the valve element, and
the initial motor torque setting means sets the initial motor torque of the electric motor so that the initial motor torque equals a torque corresponding to a force obtained by adding a force corresponding to differential pressure between the upstream fluid pressure and the downstream fluid pressure which are detected by the differential pressure detection means to the biasing force of the contracted spring or a value proximate thereto.
